(19) United States
(12) Patent Application Publication
(10) Pub. No.: US 2016/0117405 A1
(43) Pub. Date: Apr. 28, 2016

(54) Information Processing Method and Apparatus

(71) Applicant: Huawei Technologies Co., Ltd., Shenzhen (CN)

(72) Inventors: Jie Zhang, Shenzhen (CN); Yibo Zhang, Shenzhen (CN)

(21) Appl. No.: 14/988,959

(22) Filed: Jan. 6, 2016

Related U.S. Application Data
(63) Continuation of application No. PCT/CN2014/080799, filed on Jun. 26, 2014.

(30) Foreign Application Priority Data
Feb. 24, 2014 (CN) 201410063323.5

(51) Int. Cl. G06F 17/30; H04L 29/06

(52) U.S. Cl. CPC G06F 17/30867; G06F 17/30525; G06F 17/30528; G06F 17/30365; G06F 17/30368; H04L 65/403

(57) ABSTRACT

Information processing method and apparatus relating to the field of communications and information processing technologies is presented. The method and apparatus can include acquiring a search criterion entered by a user, where the search criterion includes a name of an entity and selecting, according to the name of the entity, a target triplet including the name of the entity from a knowledge base that is created in advance, where the target triplet further includes an attribute of the entity and an attribute value of the attribute, and displaying the name of the entity, the attribute of the entity, and the attribute value of the attribute.

### CROSS-REFERENCE TO RELATED APPLICATIONS

This application is a continuation of International Application No. PCT/CN2014/080799, filed on Jun. 26, 2014, which claims priority to Chinese Patent Application No. 201410063323.5, filed on Feb. 24, 2014, both of which are hereby incorporated by reference in their entireties.

### TECHNICAL FIELD

The present disclosure relates to the field of information processing technologies, and in particular, to an information processing method and apparatus.

### BACKGROUND

Social media, refers to a website, such as Facebook or Microblog, on which people are allowed to write, share, make comments, discuss, and communicate with each other. In the modern society, social media gradually evolve into a popular editorial platform, and more institutions and public characters release or disseminate information using social media. Therefore, social media has become an important way for a user to acquire information.

However, a scale of information on social media is large, and how to acquire information useful to the user from a massive amount of information on social media becomes a problem needing to be resolved. For the problem, an existing solution is to perform searching using a keyword (or a phrase) entered by a user on social media, displaying a list of information related to the keyword (or a phrase) to the user, and then selecting, by the user from the information list, information needed by the user.

However, because social media have a massive amount of information, information in the information list obtained by searching for after a keyword (or a phrase) is entered in the prior art is relatively much, and the user needs to select, from multiple pieces of information in the information list, the information needed by the user. Therefore, it is not very convenient for the user to acquire the information needed by the user.

### SUMMARY

In view of this, the present disclosure provides an information processing method and apparatus, so as to help a user to acquire information that is needed by the user.

To achieve the foregoing objective, the following technical solutions are used in embodiments of the present disclosure.

According to a first aspect, the present disclosure provides an information processing method, including acquiring a search criterion entered by a user, where the search criterion includes a name of an entity, selecting, according to the name of the entity, a target triplet including the name of the entity from a knowledge base that is created in advance, where the target triplet further includes an attribute of the entity and an attribute value of the attribute, and displaying the name of the entity, the attribute of the entity, and the attribute value of the attribute.

With reference to the first aspect, in a first possible implementation manner of the first aspect, before the selecting, according to the name of the entity, a target triplet including the name of the entity from a knowledge base that is created in advance, the method further includes creating the knowledge base using information released on social media.

With reference to the first possible implementation manner of the first aspect, in a second possible implementation manner of the first aspect, the creating the knowledge base using information released on social media further includes extracting a name of an entity, an attribute, and an attribute value that are in the information released on social media, generating a triplet including the name of the entity, the attribute, and the attribute value, and creating the knowledge base using the triplet including the name of the entity, the attribute, and the attribute value.

With reference to the second possible implementation manner of the first aspect, in a third possible implementation manner of the first aspect, the generating a triplet including the name of the entity, the attribute, and the attribute value further includes setting the name of the entity, the attribute, and the attribute value in a preset template using a pattern extractor, and generating, according to the template, the triplet including the name of the entity, the attribute, and the attribute value.

With reference to the second possible implementation manner of the first aspect or the third possible implementation manner of the first aspect, in a fourth possible implementation manner of the first aspect, before the creating the knowledge base using the triplet including the name of the entity, the attribute, and the attribute value, the method further includes checking, using a pre-established schema specification, the triplet including the name of the entity, the attribute, and the attribute value.

With reference to any one of the first to the fourth possible implementation manners of the first aspect, in a fifth possible implementation manner of the first aspect, the method further includes updating the knowledge base in real time.

With reference to the fifth possible implementation manner of the first aspect, in a sixth possible implementation manner of the first aspect, the updating the knowledge base in real time further includes acquiring, in real time, information released on social media, determining whether a name of entity that already exists in the knowledge base exists in the released information, and if the name of entity that already exists in the knowledge base exists in the released information, updating the knowledge base using a new triplet including the name of entity, an attribute, and an attribute value that are in the released information, or if the name of entity that does not exist in the knowledge base exists in the released information, storing, in the knowledge base, a new triplet including the name of entity, an attribute, and an attribute value that are in the released information, so as to update the knowledge base.

With reference to the first aspect or any one of the first to the sixth possible implementation manners of the first aspect, in a seventh possible implementation manner of the first aspect, the search criterion further includes the attribute of the entity, the selecting, according to the name of the entity, a target triplet including the name of the entity from a knowledge base that is created in advance. The target triplet further includes an attribute of the entity and an attribute value of the attribute which includes selecting, according to the name of the entity and the attribute of the entity, the target triplet including the name of the entity and the attribute of the entity from the knowledge base that is created in advance, where the target triplet further includes the attribute value of the attribute.

According to a second aspect, the present disclosure provides an information processing apparatus, including an acquiring unit configured to acquire a search criterion entered by a user, where the search criterion includes a name of an entity, a selection unit, connected to the acquiring unit, and configured to select, according to the name of the entity, a target triplet including the name of the entity from a knowledge base that is created in advance, where the target triplet further includes an attribute of the entity and an attribute value of the attribute, and a display unit, connected to the selection unit, and configured to display the name of the entity, the attribute of the entity, and the attribute value of the attribute.

In a first possible implementation manner of the second aspect, the apparatus further includes a knowledge base creating unit, connected to the selection unit, and configured to create the knowledge base using information released on social media.

With reference to the first possible implementation manner of the second aspect, in a second possible implementation manner of the second aspect, the knowledge base creating unit includes an acquiring subunit configured to acquire a name of an entity, an attribute, and an attribute value that are in the information released on social media. In addition, a generating subunit, connected to the acquiring subunit, and configured to generate a triplet including the name of the entity, the attribute, and the attribute value that are extracted by the acquiring subunit, and a creating subunit, connected to the generating subunit, and configured to create the knowledge base using the triplet that is generated by the generating subunit and that includes the name of the entity, the attribute, and the attribute value.

With reference to the second possible implementation manner of the second aspect, in a third possible implementation manner of the second aspect, the generating subunit is further configured to set the name of the entity, the attribute, and the attribute value in a preset template using a pattern extractor, and generating, according to the template, the triplet including the name of the entity, the attribute, and the attribute value.

With reference to the second possible implementation manner of the second aspect or the third possible implementation manner of the second aspect, in a fourth possible implementation manner of the second aspect, the knowledge base creating unit further includes a checking subunit, connected to the generating subunit and the creating subunit, and configured to check, using a pre-established schema specification, the triplet that is generated by the generating subunit and that includes the name of the entity, the attribute, and the attribute value.

With reference to any one of the first to the fourth possible implementation manners of the second aspect, in a fifth possible implementation manner of the second aspect, the knowledge base creating unit further includes an update subunit, connected to the creating subunit, and configured to update, in real time, the knowledge base created by the creating subunit.

With reference to the fifth possible implementation manner of the second aspect, in a sixth possible implementation manner of the second aspect, the update subunit includes an acquiring module configured to acquire, in real time, the information released on social media, a determining module, connected to the acquiring module, and configured to determine whether a name of entity that already exists in the knowledge base exists in the released information acquired by the acquiring module, and an update module, connected to the determining module, and configured to when the determining module determines that the name of entity that already exists in the knowledge base exists in the released information, update the knowledge base using a new triplet including the name of entity, an attribute, and an attribute value that are in the released information. When the determining module determines that a name of entity that does not exist in the knowledge base exists in the released information, store, in the knowledge base, a new triplet including the name of entity, an attribute, and an attribute value that are in the released information, so as to update the knowledge base.

With reference to the second aspect and any one of the first to the sixth possible implementation manners of the second aspect, in a seventh possible implementation manner of the second aspect, the search criterion acquired by the acquiring unit further includes the attribute of the entity. The selection unit is further configured to select, according to the name of the entity and the attribute of the entity, the target triplet including the name of the entity and the attribute of the entity from the knowledge base that is created in advance, where the target triplet further includes the attribute value of the attribute.

According to the information processing method and apparatus that are provided in the embodiments of the present disclosure, a search criterion entered by a user is acquired, a target triplet related to the search criterion is selected, according to the search criterion, from a knowledge base that is created in advance, and then, the information about the target triplet is displayed. According to the search criterion entered by the user, the information about the target triplet is displayed to the user, and in the prior art, according to a search criterion entered by a user, a list including multiple pieces of information is displayed to the user. Therefore, compared with the prior art, according to the information processing method and apparatus that are provided in the embodiments of the present disclosure, a defect that it is relatively troublesome for a user to still need to select, from multiple pieces of information, information that is needed by the user can be avoided, thereby making it convenient for the user to acquire the information that is needed by the user.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a flowchart of an information processing method according to Embodiment 1 of the present disclosure;

FIG. 2 is a flowchart of an information processing method according to Embodiment 2 of the present disclosure;

FIG. 3 is a schematic diagram of information released by a user on a website of social media;

FIG. 4 is a flowchart of specific steps of step 21 according to Embodiment 2 of the present disclosure;

FIG. 5 is a schematic diagram of an information processing process in Embodiment 2 of the present disclosure;

FIG. 6 is a schematic diagram of an information processing apparatus according to Embodiment 3 of the present disclosure;

FIG. 7 is another schematic diagram of an information processing apparatus according to Embodiment 3 of the present disclosure;

FIG. 8 is another schematic diagram of an information processing apparatus according to Embodiment 3 of the present disclosure; and

FIG. 9 is a schematic structural diagram of an information processing device according to Embodiment 4 of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

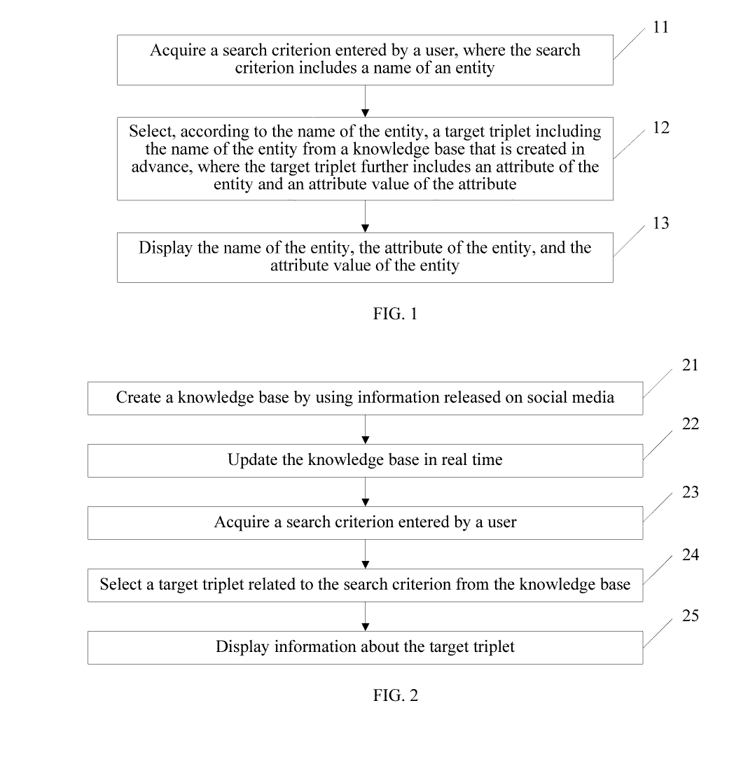

To help a user to acquire, from information released on social media, information that is needed by the user, as shown in FIG. 1, Embodiment 1 of the present disclosure provides an information processing method, which includes:

Step 11: Acquire a search criterion entered by a user, where the search criterion includes a name of an entity.

The search criterion may be a search keyword, a phrase, a questioning sentence, or the like that is entered by the user on a user query interface of social media to acquire the information that is needed by the user, for example, a questioning sentence such as “What is the height of Yao Ming′?” or “Where is the ancestral home of Andy Lau?” that is entered on a social media website. For another example, an entered keyword such as “Yao Ming height” or “Andy Lau ancestral home”.

The search criterion generally includes an entity, and the entity has many characteristics, such as a name of the entity, an attribute, and an attribute value. Herein, the concept of “entity” is briefly described. Entities are objects that objectively exist and can be distinguished from one another, and may be a concrete person, thing, and object, or may be an abstract concept, association, or the like. An entity may be identified using the name of the entity. Either a property of the entity or a relationship between the entity and another entity can be referred to as an attribute of the entity. An attribute value is quality or a quantity that accurately indicates an attribute of an entity. In this embodiment, the entity in the search criterion is referred to as a target entity. The search criterion includes information about the target entity, such as a name of the target entity, an attribute, and an attribute value. For example, “Yao Ming” and “Andy Lau” in the foregoing example are names of target entities, and “height” and “ancestral home” are attributes of the target entities. If it is known that the height of Yao Ming is 2.26 meters, “2.26 meters” is an attribute value of the attribute “height”.

The search criterion may include only one of the name of the target entity, the attribute, and the attribute value. In most cases, the search criterion may include only the name of the target entity. For example, if a user wants to acquire information about the entity “Yao Ming”, the search criterion may include only the name “Yao Ming” of the entity.

In addition, because a user often acquires an answer to a question by entering a questioning sentence, in this case, the search criterion generally includes a combination of any two of the three, the name of the target entity, the attribute, and the attribute value. That is either includes only the name of the target entity and the attribute, or only the name of the target entity and the attribute value, or only the attribute of the target entity and the attribute value, and the remaining one of the three, that is either the name of the target entity or the attribute or the attribute value is the information that needs to be acquired by the user. For example, if the search criterion is “What is the height of Yao Ming?”, the search criterion includes only the name “Yao Ming” of the target entity and the attribute “height” of the target entity, and the attribute value of the target entity is the information that needs to be acquired by the user.

Step 12: Select, according to the name of the entity, a target triplet including the name of the entity from a knowledge base that is created in advance, where the target triplet further includes an attribute of the entity and an attribute value of the attribute.

The knowledge base that is created in advance stores multiple triplets including the names of entities, attributes, and attribute values, where the “attribute” may be an “attribute name” or a “relationship name”. When the “attribute” is the “attribute name”, a form of the triplet may be (entity, attribute name, attribute value), for example, (Yao Ming, height, 2.26 meters) and (Xiangshan, quantity of people, small). When the “attribute” is the “relationship name”, a form of the triplet may be (entity, relationship name, attribute value), for example, (Nicholas Tse, father, Patrick Tse).

The target triplet includes a name of an entity, an attribute, and an attribute value that are related to the information about the target entity in the search criterion.

Using the example in step 11 as an example, the search criterion entered by the user is “What is the height of Yao Ming?”. First, the target entity in the search criterion is recognized, and a result obtained through the recognition is that the name of the target entity is “Yao Ming”, and the attribute of the target entity is “height”. Then, a triplet related to the name “Yao Ming” of the target entity and the attribute “height” of the target entity, that is, a triplet including “Yao Ming” and “height” is selected from the knowledge base. If the triplet that is in the knowledge base and that is related to “Yao Ming” and “height” is (Yao Ming, height, 2.26 meters), the triplet (Yao Ming, height, 2.26 meters) is the target triplet herein. The target entity may be recognized using a method for recognizing a named entity in the prior art.

Step 13: Display the name of the entity, the attribute of the entity, and the attribute value of the attribute.

In an actual application, this step further comprises displaying the target triplet, the name of the entity that corresponds to the search criterion, the attribute of the entity that corresponds to the search criterion, or the attribute value of the entity that corresponds to the search criterion.

For example, if the search criterion is “What is the height of Yao Ming?”, if the target triplet that is related to the search criterion “What is the height of Yao Ming′?” and that is selected from the knowledge base that is created in advance is (Yao Ming, height, 2.26 meters), the target triplet (Yao Ming, height, 2.26 meters) may be displayed to the user. Alternatively, it may be known according to the search criterion “What is the height of Yao Ming′?” that, the information needed by the user is only the attribute value, that is, 2.26 meters, in the target triplet (Yao Ming, height, 2.26 meters), and in this case, only 2.26 meters may be displayed to the user.

For another example, if the user enters “Whose father is Patrick Tse?”, if a target triplet that is related to the search criterion “Whose father is Patrick Tse?” and that is selected from the knowledge base that is created in advance is (Nicholas Tse, father, Patrick Tse), the target triplet (Nicholas Tse, father, Patrick Tse) may be displayed to the user. Alternatively, it may be known according to the search criterion “Whose father is Patrick Tse?” that, the information needed by the user is only the name of an entity in the target triplet (Nicholas Tse, father, Patrick Tse), and in this case, only “Nicholas Tse” may be displayed to the user.

It can be seen from the above that, according to the information processing method provided in Embodiment 1 of the present disclosure, a search criterion entered by a user is acquired, a target triplet related to the search criterion is selected, according to the search criterion, from a knowledge base that is created in advance, and then, information about the target triplet is displayed. According to the search criterion entered by the user, the information about the target triplet is displayed to the user, and in the prior art, according to a search criterion entered by a user, a list including multiple pieces of information is displayed to the user. Therefore, compared with the prior art, according to the information processing method provided in this embodiment of the present disclosure, a defect that it is relatively troublesome for a user to still need to select, from multiple pieces of information, information that is needed by the user can be avoided, thereby making it convenient for the user to acquire the information that is needed by the user.

The information processing method of the present disclosure is described below in further detail in Embodiment 2 of the present disclosure. As shown in FIG. 2, the information processing method provided in Embodiment 2 of the present disclosure includes:

Step 21: Create a knowledge base by using information released on social media.

The information released on social media refers to information that is released by a user on a website of social media, for example, information shown in a screenshot of FIG. 3.

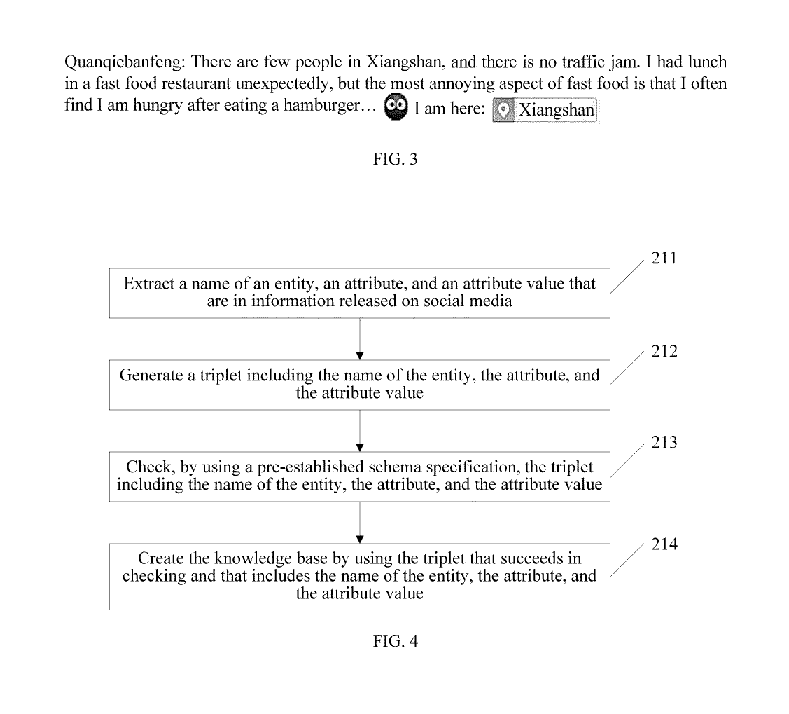

In an actual application, as shown in FIG. 4, this step further includes:

Step 211: Extract a name of an entity, an attribute, and an attribute value that are in the information released on social media.

The information released on social media may be acquired using a crawler or an application programming interface (API), and then, the name of the entity, the attribute, and the attribute value that are in the information are acquired using a pattern extractor that is obtained by training offline in advance. It should be noted that in this step, the name of the entity, the attribute, and the attribute value are acquired online.

In an actual application, a specific implementation manner of acquiring the name of the entity, the attribute, and the attribute value using a pattern extractor may include the following. First, existing annotated linguistic data or an existing structured knowledge base (for example, the inbox of Baidu Baike) on a network is used as training materials of the pattern extractor. Multiple triplets are acquired from these training materials, and then these triplets are annotated in a corpus of natural language texts, using these triplets as training data. Then, a separate attribute pattern classifier is trained, from the training data, for each attribute using a statistical machine learning algorithm. For example, a conditional random field (CRF). Finally, the pattern extractor can extract, using the attribute pattern classifier, the name of the entity, the attribute, and the attribute value from the information released on social media.

Step 212: Generate a triplet including the name of the entity, the attribute, and the attribute value.

In an actual application, the name of the entity, the attribute, and the attribute value may be set in a preset template using the pattern extractor, and the triplet including the name of the entity, the attribute, and the attribute value is generated according to the template.

Natural language texts corresponding to a name of each entity, an attribute, and an attribute value may be found in advance in a corpus using a statistical learning method, so that an attribute template corresponding to each entity is generated. Each entity may have multiple attribute templates. The attribute template is, for example, (name of a person, height, number) or (name of a scenic spot, quantity of people, number). The attribute template is the preset template herein. After the name of the entity, the attribute, and the attribute value are acquired in step 211, the pattern extractor may load the name of the entity, the attribute, and the attribute value that are acquired online to the preset template, so that the triplet including the name of the entity, the attribute, and the attribute value is generated.

Step 211 and step 212 are described below using an example. For example, the information released on social media is “Yao Ming, 2.26 meters tall, born in Shanghai, China on Sep. 12, 1980, an ancestral home being Wujiang District, Suzhou City, Jiangsu, graduated from Shanghai Jiaotong University”.

First, the name of the entity, the attribute, and the attribute value are extracted using the pattern extractor that is obtained by training offline. In this example, for the name of the entity, there is only “Yao Ming”, for the attribute of the entity, there is “height”, “date of birth”, “birthplace”, “ancestral home”, and “graduated from”, and attribute values corresponding to these attributes are respectively “2.26 meters”, “Sep. 12, 1980”, “Shanghai, China”, “Wujiang District, Suzhou City, Jiangsu”, and “Shanghai Jiaotong University”. In this case, the name of the entity, the attributes, and the attribute values may be loaded to the preset templates using the pattern extractor. Because there are multiple attributes of the entity and multiple attribute values corresponding to the attributes in this example, multiple preset templates need to be used. In this example, the preset templates may be (name of a person, height, number), (name of a person, date of birth, date), (name of a person, birthplace, name of a place), (name of a person, ancestral home, name of a place), and (name of a person, graduated from, name of a school). After the name of the entity, the attributes, and the attribute values are set in the preset templates using an attribute extractor, triplets, that is, (Yao Ming, height, 2.26 meters), (Yao Ming, date of birth, Sep. 12, 1980), (Yao Ming, birthplace, Shanghai, China), (Yao Ming, ancestral home, Wujiang District, Suzhou City, Jiangsu), and (Yao Ming, graduated from, Shanghai Jiaotong University), including the name of the entity, the attributes, and the attribute values are generated.

It can be seen from this example that, multiple triplets may be obtained using the information released on social media. Even though there is only one name of the entity in this example, it is not hard to imagine that in an actual application, there may also be multiple names of entities released on social media, and in this case, a triplet corresponding to each entity may be generated for each entity.

Step 213: Check, using a pre-established schema specification, the triplet including the name of the entity, the attribute, and the attribute value.

Checking the triplet using the pre-established schema specification is mainly checking, using the schema specification, whether the information about the triplet generated in step 212 is logical, or whether the information is correct. Only a triplet succeeding in checking can be stored in the knowledge base.

For example, if the triplet generated in step 212 using the information released on social media is (Yao Ming, height, 2.26 centimeters), after checking is performed using the schema specification, a result is that the triplet is illogical, and is an incorrect triplet. Therefore, the triplet does not need to be stored in the created knowledge base.

In addition, same names of an entity, same attributes, and same attribute values that are in the information released on social media may have different expression manners, for example, names “Wang Zhizhi” and “Da Zhi” of an entity both refer to “Wang Zhizhi”, attributes “height”, “body length”, “high”, and “tall” all refer to “height”, attribute values “184 cm”, “1.84 meters”, and “6 feet” all refer to “1.84 meters”. Therefore, when the triplet is checked using the pre-established schema specification, “disambiguation” processing may further be performed on expression manners of the names of the entity, the attributes, and the attribute values, that is, when a name of an entity, an attribute, and an attribute value that are acquired from a piece of information released on social media are A, B, and C, respectively, a name of an entity, an attribute, and an attribute value that are acquired from another piece of information released on social media are A1, B1, and C1, respectively. Then A and A1 refer to a same entity, B and B1 refer to a same attribute, and C and C1 refer to a same attribute value, and both triplets generated according to the two pieces of information may be stored as (A, B, C).

For example, if a triplet generated using a piece of information released on social media is (Wang Zhizhi, height, 2.14 meters), and a triplet generated using another piece of information released on social media is (Da Zhi, tall, 214 centimeters), both of the two triplets may be stored as (Wang Zhizhi, height, 2.14 meters).

Step 214: Create the knowledge base by using the triplet that succeeds in checking and that includes the name of the entity, the attribute, and the attribute value.

The triplet in step 213 that succeeds in checking may be stored, and may be stored in, for example, a memory or a hard disk, so as to complete creating of the knowledge base.

For example, using the example in step 211 and step 212 as an example, after the five triplets (Yao Ming, height, 2.26 meters), (Yao Ming, date of birth, Sep. 12, 1980), (Yao Ming, birthplace, Shanghai, China), (Yao Ming, ancestral home, Wujiang District, Suzhou City, Jiangsu), and (Yao Ming, graduated from, Shanghai Jiaotong University) are generated, the five triplets are then checked using the schema specification, and after succeeding in checking, the five triplets may be stored in the memory, so that the knowledge base is created.

In a specific application, triplets in the knowledge base may be categorized according to categories of entities, for example, the triplets in the knowledge base may be classified into multiple categories, such as characters, animals, plants, and commodities, according to the categories of entities. The foregoing five triplets all belong to the category of characters.

Step 22: Update the knowledge base in real time.

This step is further comprising, acquiring the released information from social media at a preset time interval, and determining whether the name of entity that already exists in the knowledge base exists in the information. If the name of entity that already exists in the knowledge base exists in the information, updating the knowledge base using the new triplet including the name of entity, an attribute, and an attribute value that are in the information, or if the name of entity that does not exist in the knowledge base information, storing, in the knowledge base, a new triplet including the name of entity, an attribute, and an attribute value that are in the information, so as to update the knowledge base. The preset time interval may be set according to a specific case, and an objective is to acquire, in real time, the information released on social media. For example, the preset time interval may be set to 1 second.

For example, it is assumed that a triplet generated using the information released on social media is (Andy Lau, concert, 90^{th}), and is already stored in the knowledge base. Information that is released on social media and that is acquired in real time is “Andy Lau is going to give the 100^{th} concert in . . . ”, a triplet generated using the information is (Andy Lau, concert, 100^{th}), and it can be seen that the name of entity “Andy Lau” that already exists in the knowledge base exists in the information; therefore, the triplet (Andy Lau, concert, 100^{th}) may be stored in the knowledge base, and the original triplet (Andy Lau, concert, 90^{th}) is deleted, so as to update the knowledge base.

If a triplet stored in the knowledge base is (Andy Lau, concert, 90^{th}), there is only this one triplet, and information that is released on social media and that is acquired in real time is “Andy Lau is going to give the 100^{th} concert in . . . Yao Ming . . . retired . . . in 2011”. It can be seen that, names of entities in the information is “Andy Lau” and “Yao Ming”, and the triplets generated using the information are (Andy Lau, concert, 100^{th}) and (Yao Ming, retire, 2011). The name of entity “Andy Lau” that already exists in the knowledge base exists in the information, and the name of entity “Yao Ming” that does not exist in the knowledge base also exists in the information. Therefore, the triplet (Andy Lau, concert, 90^{th}) that already exists in the knowledge base may be updated using (Andy Lau, concert, 100^{th}), and (Yao Ming, retire, 2011) is also stored in the knowledge base, so as to update the knowledge base.

It should be noted that, if an name of entity that already exists in the knowledge base exists in the information, there are mainly two cases for updating the knowledge base using the new triplet including the name of the entity, the attribute, and the attribute value that are in the information.

Case 1: A name of an entity in an original triplet in the knowledge base is the same as a name of a triplet (new triplet) extracted from the information that is released on social media and that is acquired in real time, an attribute of the entity in the original triplet is the same as an attribute of the new triplet, and only attribute values of the entities in the original triplet and the new triple are different. In this case, the original triplet may be replaced with the new triplet, and the new triplet is stored in the knowledge base, so as to update the knowledge base. For example, (Andy Lau, concert, 90^{th}) is replaced with (Andy Lau, concert, 100^{th}), and (Andy Lau, concert, 100^{th}) is stored in the knowledge base.

Case 2: Even though a name of entity that already exists in the knowledge base may exist in the information, attributes of entities in the original triplet and the new triplet are different. In this case, the updating the knowledge base using the new triplet including the name of the entity, the attribute, and the attribute value that are in the information is storing the new triplet in the knowledge base. For example, if in the foregoing example, triplets generated using the information that is released on social media in real time further include (Andy Lau, birthplace, Hong Kong), even though the names of the entities in the original triplet and the new triplet are the same, because the attribute of the new triplet is different from the attribute of the original triplet in the knowledge base, the new triplet also needs to be stored in the knowledge base, so as to update the knowledge base.

Step 23: Acquire a search criterion entered by a user.

Information, which needs to be searched for, about an entity is acquired from the search criterion, and the information about the entity may be a name of the entity, or may be a name of the entity and an attribute of the entity.

For this step, reference may be made to the descriptions in step 11 of Embodiment 1 of the present disclosure, and details are not described herein again.

Step 24: Select a target triplet related to the search criterion from the knowledge base.

Selecting a target triplet related to the search criterion from the knowledge base may be selecting, according to the name of the entity, the target triplet including the name of the entity from the knowledge base that is created in advance, where the target triplet further includes the attribute of the entity and the attribute value of the attribute.

The selecting a target triplet related to the search criterion from the knowledge base may also be selecting, according to the name of the entity and the attribute of the entity, the target triplet including the name of the entity and the attribute of the entity from the knowledge base that is created in advance, where the target triplet further includes the attribute value of the attribute.

In an actual application, using the example in step 21 as an example, if the search criterion entered by the user in step 23 is “Where is the birthplace of Yao Ming?”, when the target triplet is selected in the knowledge base, how to select the target triplet may be determined according to whether triplets in the knowledge base are already categorized.

If the triplets in the knowledge base are already categorized into multiple categories, such as characters, animals, plants, and commodities when the knowledge base is created, the category of characters that is related to the entity in the search criterion may be first selected according to the categorization performed on the triplets in the knowledge base, and then the target triplet (Yao Ming, birthplace, Shanghai, China) is selected from the category of characters.

If the triplets in the knowledge base are not categorized when the knowledge base is created, when the target triplet is selected, the target triplet related to the search criterion may be selected from the knowledge base according to the name of the entity, the attribute, or the attribute value in the search criterion. For example, using the foregoing example as an example, the name “Yao Ming” of the entity and the attribute “birthplace” can be known according to the search criterion, and when the target triplet is selected from the knowledge base, a triplet including “Yao Ming” and “birthplace” is selected from the multiple triplets in the knowledge base as the target triplet, that is, (Yao Ming, birthplace, Shanghai, China).

Step 25: Display information about the target triplet.

For this step, reference may be further made to the descriptions in step 13 of Embodiment 1 of the present disclosure, and details are not described herein again.

For example, using the example in step 24 as an example, (Yao Ming, birthplace, Shanghai, China) or only Shanghai, China may be displayed to the user according to the search criterion entered by the user.

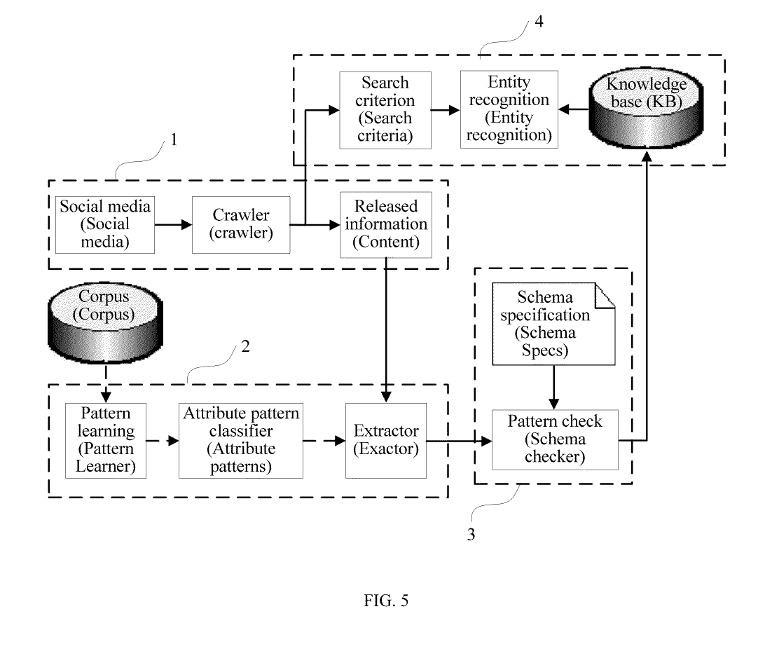

FIG. 5 schematically shows an information processing process of step 21 to step 25. As shown in FIG. 5, in a specific application, the information processing method in Embodiment 2 of the present disclosure is mainly divided into four parts, which are shown in dashed boxes 1 to 4 separately.

The dashed box 1 is the first part, and shows a process of acquiring information from social media. That is, the information on the social media is acquired using a crawler. The information mainly includes two parts, where one part is information released (content) by the user on social media, and the other part is the search criterion (search criteria) that is entered by the user on a user query interface of social media.

The dashed box 2 is the second part, and shows a process of how to extract, by a pattern extractor, a triplet from the content on the social media, that is, existing triplets are first acquired from a corpus, then, these triplets are annotated in the corpus of natural language texts for attribute pattern learning, to train a separate attribute pattern classifier for each attribute, and the pattern extractor (Extractor) extracts, using the attribute pattern classifier (attribute patterns), the target triplet (not shown in the figure) from the content on the social media.

The dashed box 3 is the third part, and shows a process of performing schema checking on the triplet extracted by the pattern extractor, that is, schema checking is first performed on the triplet using a pre-established schema specification (schema specs), and then the triplet succeeding in checking is stored in the knowledge base (KB), so as to complete creating of the knowledge base.

The dashed box 4 is the fourth part, and shows a process of acquiring, using the created knowledge base and the search criteria acquired in the first part, information that is needed by the user. That is, entity recognition is first performed on the information in the search criterion according to the search criteria, and if the target entity in the search criterion exists in the KB, information about a triplet corresponding to the target entity is selected from the KB and is displayed to the user, so that the user acquires the information needed. The entity recognition may be implemented using a method for recognizing a named entity in the prior art.

In another embodiment of the present disclosure, the search criterion further includes the attribute of the entity, and the selecting, according to the name of the entity, a target triplet including the name of the entity from a KB that is created in advance, where the target triplet further includes an attribute of the entity and an attribute value of the attribute includes selecting, according to the name of the entity and the attribute of the entity, the target triplet including the name of the entity and the attribute of the entity from the KB that is created in advance, where the target triplet further includes the attribute value of the attribute, and displaying the name of the entity, the attribute of the entity, and the attribute value of the attribute.

It can be seen from the above that, according to the information processing method provided in Embodiment 2 of the present disclosure, when a user acquires, from information released on social media, information that is needed by the user, after a search criterion is entered, information about a target triplet may be displayed, and in the prior art, a list including multiple pieces of information is displayed to a user according to a search criterion entered by the user. Therefore, compared with the prior art, according to the information processing method provided in Embodiment 2 of the present disclosure, a defect that it is relatively troublesome for a user to still need to select, from multiple pieces of information, the information that is needed by the user can be avoided, thereby making it convenient for the user to acquire the information that is needed by the user.

In addition, according to the information processing method provided in Embodiment 2 of the present disclosure, before the KB is created using the triplet including the name of the entity, the attribute, and the attribute value, checking may further be performed on a generated triplet, and only a triplet succeeding in checking can be stored in the KB, which ensures correctness of the triplet in the KB, and further ensures correctness of information, which is displayed to the user, about the triplet, so that the user acquires correct information. In addition, disambiguation is performed on the triplet using a schema specification, which can make the created KB more concise, and save space.

In addition, using the information processing method provided in Embodiment 2 of the present disclosure, the user can acquire the needed information more conveniently, and because the KB is updated in real time, the user can conveniently acquire the latest information. A new triplet is added to the KB, which can make content in the KB richer.

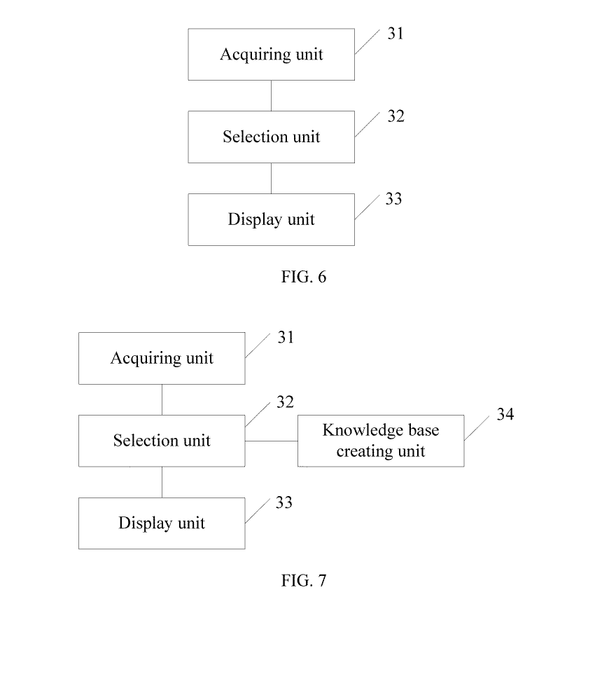

As shown in FIG. 6, Embodiment 3 of the present disclosure provides an information processing apparatus, including an acquiring unit 31 configured to acquire a search criterion entered by a user, where the search criterion includes a name of an entity, a selection unit 32, connected to the acquiring unit 31, and configured to select a target triplet including the name of the entity from a knowledge base that is created in advance, where the target triplet further includes an attribute of the entity and an attribute value of the attribute, and a display unit 33, connected to the selection unit 32, and configured to display the name of the entity, the attribute of the entity, and the attribute value of the attribute.

The search criterion acquired by the acquiring unit 31 further includes the attribute of the entity, and in this case, the selection unit 32 is further configured to select, according to the name of the entity and the attribute of the entity, the target triplet including the name of the entity and the attribute of the entity from the knowledge base that is created in advance, where the target triplet further includes the attribute value of the attribute.

The display unit 33 is further configured to display the target triplet, or display, according to the search criterion, the name of the target entity that corresponds to the search criterion, or display, according to the search criterion, the attribute of the target entity that corresponds to the search criterion, or display, according to the search criterion, the attribute value of the target entity that corresponds to the search criterion.

For a working principle of the apparatus, reference may be made to the descriptions in the foregoing method embodiments, and details are not described herein again.

It can be seen from the above that, using the information processing apparatus provided in Embodiment 3 of the present disclosure, the acquiring unit 31 acquires a search criterion entered by a user, the selection unit 32 selects, according to the search criterion, a target triplet related to the search criterion from a knowledge base that is created in advance, and then, the display unit 33 displays information about the target triplet. According to the search criterion entered by the user, the information about the target triplet is displayed to the user, and in the prior art, according to a search criterion entered by a user, a list including multiple pieces of information is displayed to the user. Therefore, compared with the prior art, according to the information processing method and apparatus that are provided in the embodiments of the present disclosure, a defect that it is relatively troublesome for a user to still need to select, from multiple pieces of information, information that is needed by the user can be avoided, thereby making it convenient for the user to acquire the information that is needed by the user.

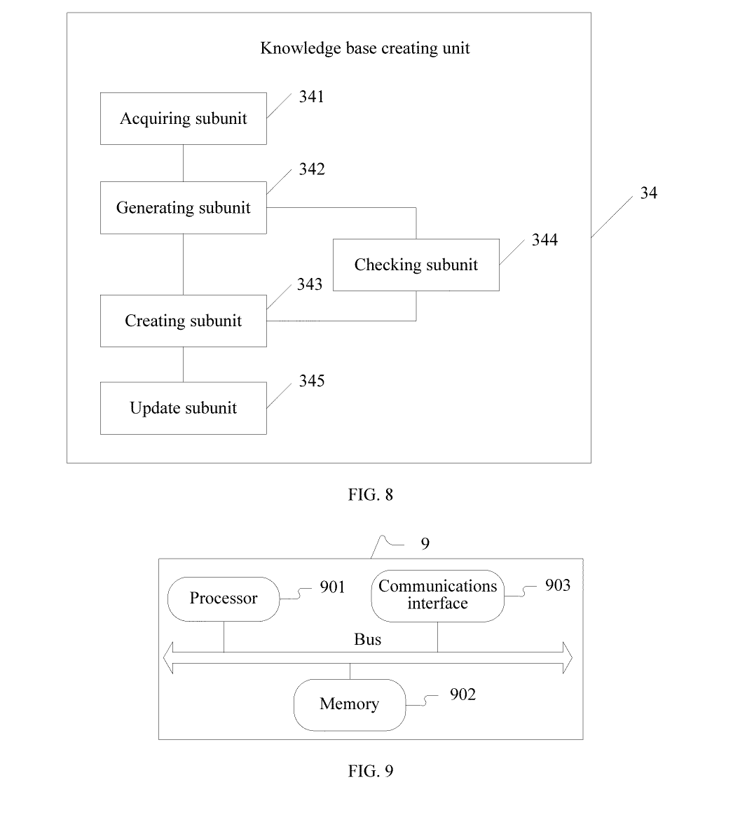

In addition, as shown in FIG. 7, the apparatus further includes a knowledge base creating unit 34, connected to the selection unit 32, and configured to create the KB using the information released on social media. As shown in FIG. 8, the knowledge base creating unit 34 further includes an acquiring subunit 341 configured to acquire the name of the entity, the attribute, and the attribute value that are in the content on social media, a generating subunit 342, connected to the acquiring subunit 341, and configured to generate a triplet including the name of the entity, the attribute, and the attribute value that are acquired by the acquiring subunit 341, and a creating subunit 343, connected to the generating subunit 342, and configured to create the KB using the triplet that is generated by the generating subunit 342 and that includes the name of the entity, the attribute, and the attribute value.

The generating subunit 342 is further configured to set the name of the entity, the attribute, and the attribute value in a preset template using a pattern extractor, and generate, according to the template, the triplet including the name of the entity, the attribute, and the attribute value.

As shown in FIG. 8, the knowledge base creating unit 34 further includes a checking subunit 344, connected to the generating subunit 342 and the creating subunit 343, and configured to check, using a pre-established schema specification, the triplet that is generated by the generating subunit 342 and that includes the name of the entity, the attribute, and the attribute value.

For a working principle of the apparatus, reference may be made to the descriptions in the foregoing method embodiments, and details are not described herein again.

It can be seen from the above that, according to the information processing apparatus provided in Embodiment 3 of the present disclosure, the checking subunit performs checking on a triplet generated by the generating subunit, which can ensure correctness of the triplet in the KB, and further ensures correctness of information, which is displayed to a user, about the triplet, so that the user acquires correct information.

In addition, as shown in FIG. 8, the knowledge base creating unit 34 further includes an update subunit 345, connected to the creating subunit 343, and configured to update, in real time, the knowledge base created by the creating subunit 343.

The update subunit 345 includes an acquiring module configured to acquire, in real time, information released on social media, a determining module, connected to the acquiring module, and configured to determine whether the name of entity that already exists in the KB exists in the information acquired by the acquiring module, an update module, connected to the determining module, and configured to update the KB using a new triplet including the name of entity, the attribute, and the attribute value that are in the information when the determining module determines that the name of entity that already exists in the KB exists in the information. when the determining module determines that the name of entity that already exists, that is not in the KB which exists in the information, store, in the KB, a new triplet including the name of entity, the attribute, and the attribute value that are in the information, so as to update the KB.

For a working principle of the apparatus, reference may be made to the descriptions in the foregoing method embodiments, and details are not described herein again.

It can be seen from the above that, using the information processing apparatus provided in Embodiment 3 of the present disclosure, the user can acquire the needed information more conveniently, and because the KB is updated by the update subunit in real time, the user can conveniently acquire the latest information.

FIG. 9 is a schematic structural diagram of an information processing device according to Embodiment 4 of the present disclosure. As shown in FIG. 9, a remote control device 9, in this embodiment includes at least one processor 901, a memory 902, a communications interface 903, and a bus. The processor 901, the memory 902, and the communications interface 903 are connected to and communicate with each other using the bus. The bus may be an industry standard architecture (ISA) bus, a peripheral component interconnect (PCI) bus, an extended industry standard architecture (EISA) bus, or the like. The bus may be classified into an address bus, a data bus, a control bus, and the like. For convenience of indication, the bus is indicated by only one bold line in FIG. 9, but it does not indicate that there is only one bus or only one type of bus.

The memory 902 is configured to store executable program code, where the program code includes a computer operation instruction. The memory 902 may include a high-speed random access memory (RAM), or may include a non-volatile memory, for example, at least one magnetic disk storage.

In an embodiment, the processor 901 runs, by reading the executable program code stored in the memory 902, a program that corresponds to the executable program code, so that the processor 901 is configured to acquire a search criterion entered by a user, where the search criterion includes a name of an entity, select, according to the name of the entity, a target triplet including the name of the entity from a knowledge base that is created in advance, where the target triplet further includes an attribute of the entity and an attribute value of the attribute, and

display the name of the entity, the attribute of the entity, and the attribute value of the attribute.

The processor 901 may be a central processing unit (CPU), or an application-specific integrated circuit (ASIC), or is configured as one or more integrated circuits implementing this embodiment of the present disclosure.

It should be noted that the processor 901 not only has the foregoing functions, but also can be configured to perform other processes in the foregoing method embodiments, and details are not described herein again.

The communications interface 903 is mainly configured to implement a traffic source of this embodiment and determine communication between a device and another device or another apparatus.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include a magnetic disk, an optical disc, a read-only memory (ROM), or a RAM.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An information processing method, comprising:
acquiring a search criterion entered by a user, wherein the search criterion comprises a name of an entity;
selecting according to the name of the entity, a target triplet comprising the name of the entity from a knowledge base that is created in advance, wherein the target triplet further comprises an attribute of the entity and an attribute value of the attribute; and
displaying the name of the entity, the attribute of the entity, and the attribute value of the attribute.

2. The information processing method according to claim 1, wherein before selecting the target triplet, the method further comprises creating the knowledge base using information released on social media.

3. The information processing method according to claim 2, wherein creating the knowledge base using information released on social media further comprises:
extracting a name of an entity, an attribute, and an attribute value that are in the information released on social media;
generating a triplet comprising the name of the entity, the attribute, and the attribute value; and
creating the knowledge base using the triplet comprising the name of the entity, the attribute, and the attribute value.

4. The information processing method according to claim 3, wherein generating the triplet comprising the name of the entity, the attribute, and the attribute value further comprises:
setting the name of the entity, the attribute, and the attribute value in a preset template using a pattern extractor; and
generating, according to the preset template, the triplet comprising the name of the entity, the attribute, and the attribute value.

5. The information processing method according to claim 3, wherein before the creating the knowledge base using the triplet comprising the name of the entity, the attribute, and the attribute value, the method further comprises checking, using a pre-established schema specification, the triplet comprising the name of the entity, the attribute, and the attribute value.

6. The information processing method according to claim 2, further comprising updating the knowledge base in real time.

7. The information processing method according to claim 6, wherein updating the knowledge base in real time further comprises:
acquiring released information from social media at a preset time interval;
determining whether the name of the entity that already exists in the knowledge base exists in the released information;
updating, when the name of the entity that already exists in the knowledge base exists in the information, the knowledge base by using a new triplet comprising a name of an entity, an attribute, and an attribute value that are in the released information.

8. The information processing method according to claim 6, wherein updating the knowledge base in real time further comprises:
acquiring released information from social media at a preset time interval;
determining whether the name of the entity that already exists in the knowledge base exists in the released information; and
storing, in the knowledge base when the name of the entity that does not exist in the knowledge base exists in the released information, a new triplet comprising a name of an entity, an attribute, and an attribute value that are in the released information, so as to update the knowledge base.

9. The information processing method according to claim 1, wherein the search criterion further comprises the attribute of the entity, and wherein selecting, according to the name of the entity, the target triplet comprising the name of the entity from the knowledge base that is created in advance, further comprises selecting, according to the name of the entity and the attribute of the entity, the target triplet comprising the name of the entity and the attribute of the entity from the knowledge base that is created in advance, wherein the target triplet further comprises the attribute value of the attribute.

10. An information processing apparatus, comprising:
an acquiring unit configured to acquire a search criterion entered by a user, wherein the search criterion comprises a name of an entity;
a selection unit connected to the acquiring unit, wherein the selection unit is configured to select, according to the name of the entity, a target triplet comprising the name of the entity from a knowledge base that is created in advance, wherein the target triplet further comprises an attribute of the entity and an attribute value of the attribute; and
a display unit connected to the selection unit, wherein the display unit is configured to display the name of the entity, the attribute of the entity, and the attribute value of the attribute.

11. The information processing apparatus according to claim 10, further comprising a knowledge base creating unit connected to the selection unit, wherein the knowledge base creating unit is configured to create the knowledge base using information released on social media.

12. The information processing apparatus according to claim 11, wherein the knowledge base creating unit comprises:
an acquiring subunit configured to acquire a name of an entity, an attribute, and an attribute value that are in the information released on social media;
a generating subunit connected to the acquiring subunit, wherein the generating subunit is configured to generate a triplet comprising the name of the entity, the attribute, and the attribute value that are acquired by the acquiring subunit; and
a creating subunit connected to the generating subunit, wherein the creating subunit is configured to create the knowledge base using the triplet, generated by the generating subunit, comprising the name of the entity, the attribute, and the attribute value.

13. The information processing apparatus according to claim 12, wherein the generating subunit is further configured to:
set the name of the entity, the attribute, and the attribute value in a preset template using a pattern extractor; and
generate, according to the preset template, the triplet comprising the name of the entity, the attribute, and the attribute value.

14. The information processing apparatus according to claim 12, wherein the knowledge base creating unit further comprises a checking subunit connected to the generating subunit and the creating subunit, wherein the checking subunit is configured to check, by using a pre-established schema specification, the triplet comprising the name of the entity, the attribute, and the attribute value that is generated by the generating subunit.

15. The information processing apparatus according to claim 12, wherein the knowledge base creating unit further comprises an update subunit connected to the creating subunit, wherein the update subunit is configured to update, in real time, the knowledge base created by the creating subunit.

16. The information processing apparatus according to claim 15, wherein the update subunit comprises:
an acquiring module configured to acquire released information from social media at a preset time interval;
a determining module connected to the acquiring module, wherein the determining module is configured to determine whether the name of the entity that already exists in the knowledge base exists in the released information acquired by the acquiring module; and
an update module connected to the determining module, wherein the update module is configured to:
update the knowledge base by using a new triplet comprising a name of the entity, an attribute, and an attribute value that are in the released information when the determining module determines that the name of the entity that already exists in the knowledge base exists in the released information; and
store, in the knowledge base, the new triplet comprising the name of the entity, the attribute, and the attribute value that are in the released information, so as to update the knowledge base when the determining module determines that the name of the entity that does not exist in the knowledge base exists in the released information.

17. The information processing apparatus according to claim 10, wherein the search criterion acquired by the acquiring unit further comprises the attribute of the entity, and wherein the selection unit is further configured to select, according to the name of the entity and the attribute of the entity, the target triplet comprising the name of the entity and the attribute of the entity from the knowledge base that is created in advance, and wherein the target triplet further comprises the attribute value of the attribute.
